(19) United States
(12) Patent Application Publication
(10) Pub. No.: US 2005/0216390 A1
(43) Pub. Date: Sep. 29, 2005

(54) System and method of managing a position in financial stock investments

(76) Inventors: Kimberly A. Snider, Dallas, TX (US); James A. Hughes, Dallas, TX (US)

Correspondence Address: FORTKORT GRETHER + KELTON LLP, 8911 N. CAPITAL OF TEXAS HWY., SUITE 3200, AUSTIN, TX, 78759, US

(21) Appl. No.: 10/807,551

(22) Filed: Mar. 23, 2004

(51) Int. Cl. G06F 17/60

(52) U.S. Cl. 705/37; 705/35

(57) ABSTRACT

The present invention provides a system and method for managing a financial investment in a combination of timed purchases of stocks and sale of options. The system and method also relates to the selection of stocks and amount of shares to purchase when to purchase shares and when and how many option contracts to sell concerning the purchased stocks. The system and method also involves the selection of multiple positions in multiple stocks and options for different sized investment funds.

### TECHNICAL FIELD OF THE INVENTION

The present invention relates generally to systems and methods for investing in financial instruments. More particularly the invention relates to managing a combination of stock, cash and option investments.

### BACKGROUND OF THE INVENTION

It is well known that profit can be made in the stock market. “Buy low—sell high” is the conventional wisdom. It is also well known that profit can be made by selling stock short. In either case, making a profit depends on correctly guessing the direction of the stock's price change. If the price of the stock rises the buyers make a profit and those selling short lose money. Conversely, if the stock price decreases the buyers lose and the short sellers make a profit. There are strategies available to reduce the risks of trading on stocks. For example: covered calls and protective puts are strategies that use options to reduce the volatility risks of investing in stocks.

The objective of the system and method taught below is to produce consistent significant yield at a reduced level of risk regardless of overall market direction or even the direction of the price of an individual security. The focus of the system is to make income on the sale of options rather than on the sale of stock that has risen in price. This is not to say that no profit is made from the sale of stock only that the focus is on making profit from premiums from the sale of options.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is a flow diagram that illustrates the flow of an embodiment of the system and method;

FIG. 2 illustrates the steps in determining what information to input in step 100 in FIG. 1;

FIG. 3 illustrates the screening process in step 130 of FIG. 1;

FIG. 4 illustrates the sorting process in step 150 of FIG. 1;

FIG. 5 illustrates the process of picking the stock and quantity of stock to purchase of step 170 of FIG. 1;

FIG. 6 illustrates the process of purchasing stock and offering option contracts of step 214 of FIG. 1;

FIG. 7 illustrates a recording keeping tool for tracking the performance of a position;

FIG. 8 illustrates another record keeping tool for tracking the price dispersion of a position;

FIG. 9 is an illustration of the flow for determination of how to record the a stock purchase in the position by band in FIG. 8;

FIG. 10 is an illustration of the process of determining if a band rule is violated;

FIG. 11 is an illustration of an embodiment of a system of bundling of stocks;

FIG. 12 is an illustration of an embodiment of a categorical breakdown of investment funds and divisor constraints for an investment fund based on the size and type of account (margin or non-margin) in which an investment will be traded;

FIG. 13 is an illustration of a table of adjustments to correct for the increased risk of unused funds in larger investment funds;

FIG. 14 is an illustration of an embodiment of a record keeping tool for category 2 funds;

FIG. 15 is an illustration of an embodiment of a system for picking stocks for a category 2 fund;

FIG. 16 is an illustration of an embodiment of a record-keeping tool for category 3 funds;

FIG. 17 is an illustration of an embodiment of a table of liquidity (open interest) constraints for different levels of purchase of a stock; and

FIG. 18 is an illustration of an embodiment of a system for picking stocks for a category 3 account.

### DETAILED DESCRIPTION OF THE INVENTION

Although the present invention is described in detail, it should be understood that various changes, substitutions and alterations can be made hereto without departing from the spirit and scope of the invention as described by the appended claims.

The objective of the system and method taught below is to produce consistent significant yield at a reduced level of risk regardless of overall market direction or price direction of an individual security. The system uses a series of investment rules applied to the selection and timing of purchase of stocks and the sale of correlated options.

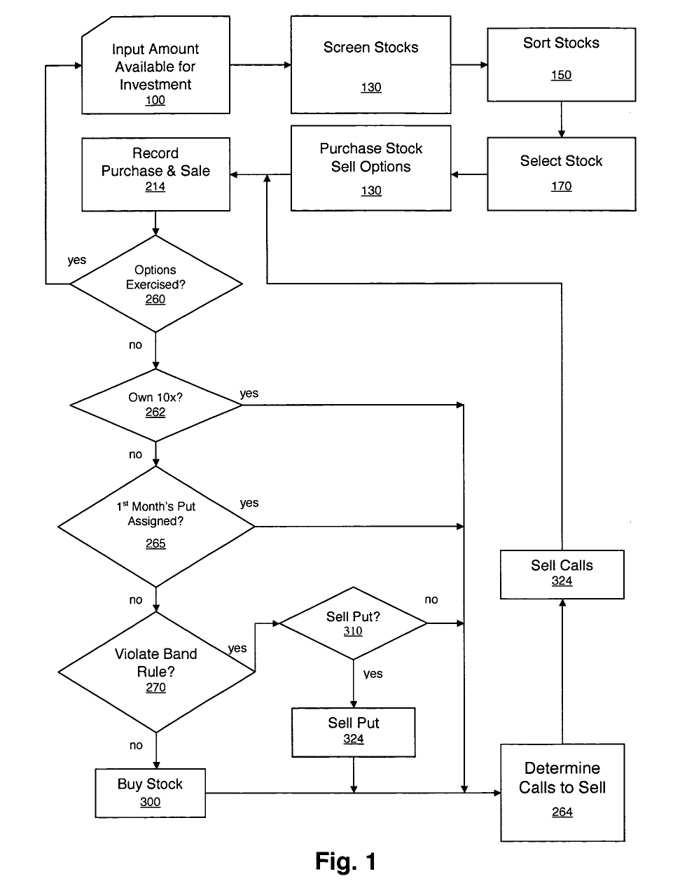

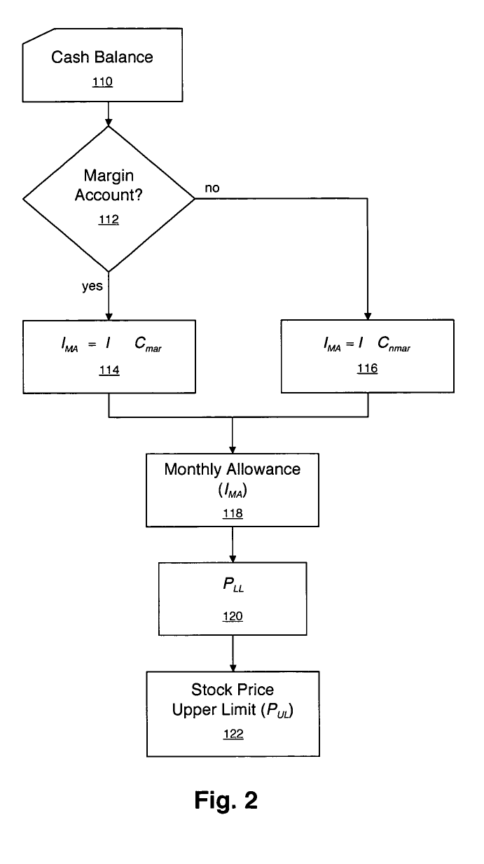

FIG. 1 illustrates one embodiment of the system and method with regard to a single position investment described below. The system may be employed in software, or a manual, guide or instructional materials or various combinations of the above or other implementations. In this embodiment the starting point concerns input to the system of the size of the investment 100 for the position. In the present embodiment this input takes the form of a monthly allowance and an upper price limit for picking the stock for the position. The determination of this input can be made through the use of a subsystem whose flow is illustrated in FIG. 2.

FIG. 2 illustrates steps to determine a monthly allowance for investment in a position, and the upper limit of the stock price to be used in selecting a stock for the position through a series of constraints. In this embodiment the determination starts with the input of the total amount of cash available 110. A determination of what to do next depends on the certain factors relating to the investment mechanism in which the cash is being handled 112. If the cash is in brokerage account with the ability to borrow on margin, account constraint (Cₘₐᵣ) is applied 114. On the other hand if the cash is not in a margin account (for example it is in a qualified plan such as an IRA) or the investor does not want take the margin risk/advantage a different non-margin constraint (Cₙₘₐᵣ) is applied 116. With either of these constraints applied the result is the monthly investment allowance 118. This is the total amount available in a month to invest in a position. In alternative embodiments the user might input the monthly allowance 118 directly rather than to go through the steps of applying the margin/non-margin funds constraints.

In the embodiment illustrated in FIG. 2, after the margin constraint (Cₘₐᵣ) or non-margin constraint (Cₙₘₐᵣ) is applied a second constraint, a stock price constraint (P_{UL}), is applied 120 to the monthly allowance 118 to set upper limits on the price of stock (P_{UL}) to select for the position 122.

For a position, an appropriate price constraint could be One Hundred (P_{LL}=100) and a suitable margin account constraint could be Five (Cₘₐᵣ=5) or a suitable non-margin account constraint could be Eight (Cₙₘₐᵣ=8). The reason different constraints are applied to funds in margin accounts and non-margin accounts is the amount of investment cash available is not the same. If the cash is being traded out of a brokerage account with margin, the investor has the ability to borrow cash in the account, thus raising the cash amount available to complete transactions. So for a maximum investment of ten times (10×) the initial investment purchase, a margin constraint of Five 5 (Cₘₐᵣ=5) would enable the investor to purchase one-hundred (100) shares up to a maximum of ten time (10×) before running out of money. This includes the money borrowed from the broker on margin. The investor will not purchase the same stock ten times unless the price of the stock has been declining, so the investor should not have to use margin until about the eighth month. This calculation is designed to get the most out of the investor's cash by using some of the margin available, but minimize the chance of a margin call. It is a balance between the risks of not putting the money to work and the risk of a margin call. In accounts without margin, less money is available in the monthly allowance thereby increasing the risk that some of the money will not be invested.

The purpose of calculating a monthly allowance is to spread the purchases in a position over time. If a monthly allowance is not calculated and there is a finite amount of cash to invest, then failing to use such a limit can result in running out of cash too soon. The ability to continue buying shares increases the chances of being able to sell short-term options profitably against some or all of these shares, thus stabilizing the monthly yield. The monthly allowance and stock price limits are input 100 in FIG. 1.

Returning to FIG. 1, the next steps are to create a screened list of stocks or select a pre-screened lists of stocks, 130 and sort the list 150 to facilitate the next step picking the stocks to purchase 214. There are many options as to how select and sort the list. The following discussion addresses factors of concern in selection criteria and sorting criteria.

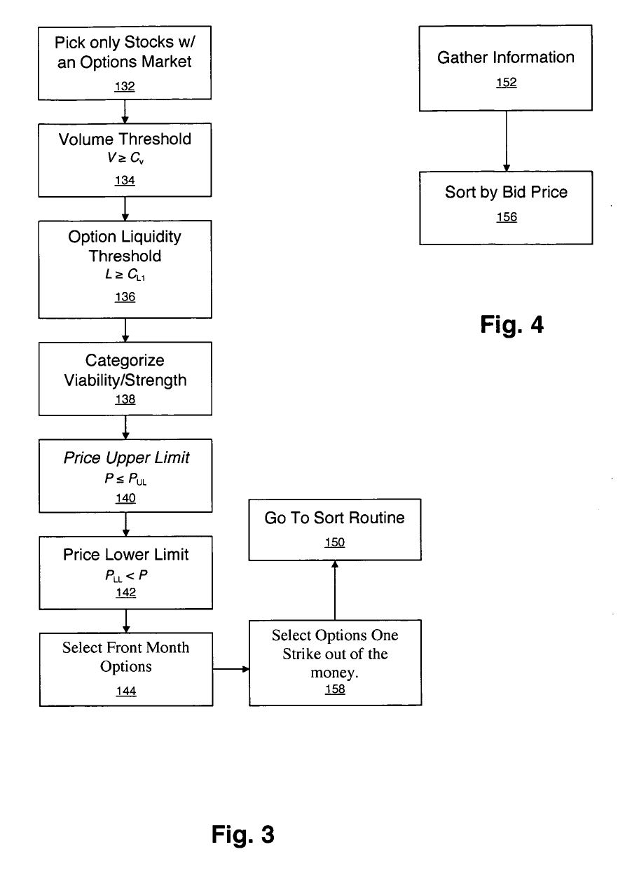

FIG. 3 is an illustration of one embodiment of a suitable screening process 130. One screening selection criteria is that the stock has an option market 132. Another criteria is that the option market for the stock is “active” 134. One possible criteria used for parameterizing “activity” of the market is the volume of trades. A current daily trading volume of greater-than-or-equal to 5 trades (Cᵥ=5→V≧5) is a reasonable constraint/threshold for determining that the option market qualifies as “active.” Stocks with option contracts with low volume can also be traded but tend to have lower return because low volume tends to increase the spreads between the bid and ask price resulting in less profit for the investor.

Liquidity is another attribute which the screening function should preferably take into account. One useful screening criterion for the liquidity of the options contracts for a stock is the “open interest” level 136. The “open interest” level represents the number of outstanding contacts. A suitable constraint/threshold for open interest level is greater-than-or-equal to One Hundred (C_{L1}=100→L≧100). Similar to the option “activity” trade volume threshold, the open interest threshold reduces the spread between the bid and ask prices of the options.

Another concern addressed by the screening process relates to the long-term viability of the issuer 138. This factor is much more important to the success of the position than the short-term or long-term price movement on the security. Very generally stated, the objective of these criteria are to screen-out stock in companies based on their relative risk of bankruptcy. For example, the Z-score bankruptcy indicator developed by Edward Altman and other similar or comparable indicators could be used. Using bankruptcy indictors, like Z-score, a screening criteria can be set based on the development of the indicators. In other embodiments other thresholds could be used. Although not shown in the FIGUREs it is also possible to create multiple lists with different screening factor constraints/thresholds. In another embodiment of the invention where the user selects a prescreened list, the user might be presented with a selection of prescreened lists with different risk profiles.

Screen out stocks over upper price limit (P_{UL}≧P) 140. Screen out stocks below a lower price limit (P≦P_{LL}). A suitable lower price limit of $25.00 has been found suitable. Studies have shown an increased risk of bankruptcy for lower priced stocks. In other embodiments, other thresholds could be used.

The simplest solution for step 130 in FIG. 1 is to select a prescreened list. There are many such lists available. For example suitable lists can be found at listing/research services such as Power Options Plus found at www.poweropt.com. In addition, the Power Options Plus service provides research and report generation tools which are useful for carrying out the select and sort operations to assist the user in selecting stocks for a position as described below.

The next step 144 is to select by Option expiration time frame. The reason for this parameter is to avoid starting the position too close to the expiration of the start of the position and to maximize the rate at which the option price declines as a function of time. The list is screened by excluding all but the options that expire in the following month.

The list of stock/option combinations is further screened to only include options one strike out of the money. These are the options with the strike price closest to the current stock price, but excluding those with strike prices below the current stock price. These options have the highest time-value component of premium, while still offering the possibility of profit from the sale of the stock.

FIG. 4 illustrates an embodiment of a sorting process 150 of the screened list of stocks. First information is gathered 152 for the screened list 130 of stocks and options. In this embodiment the following information is gathered: (1) with respect to the stocks—the stock symbol, the company name, and the last stock price; and (2) with respect to the options—the option symbol, the expiration date and the strike price, the option bid price and the bid price as a percentage of the stock price. In other embodiments, the implied or historical volatility could be included.

The next step is to sort the list of stock/option combinations by the Option Bid Price from highest to lowest. For reasons that will be appreciated below, the more expensive options are of greater interest since it is what the investor will be selling and the plan is agnostic to the direction of the stock. Returning again to FIG. 1 a screened and sorted list of stocks has been created. And steps 130 and 150 are complete. The next step is to pick the stock to purchase—step 170.

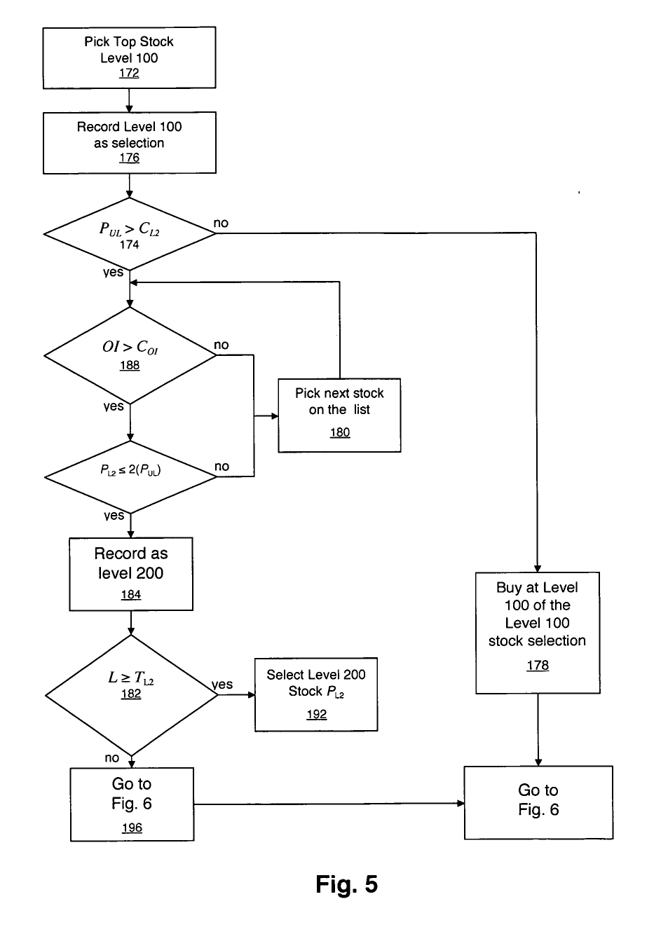

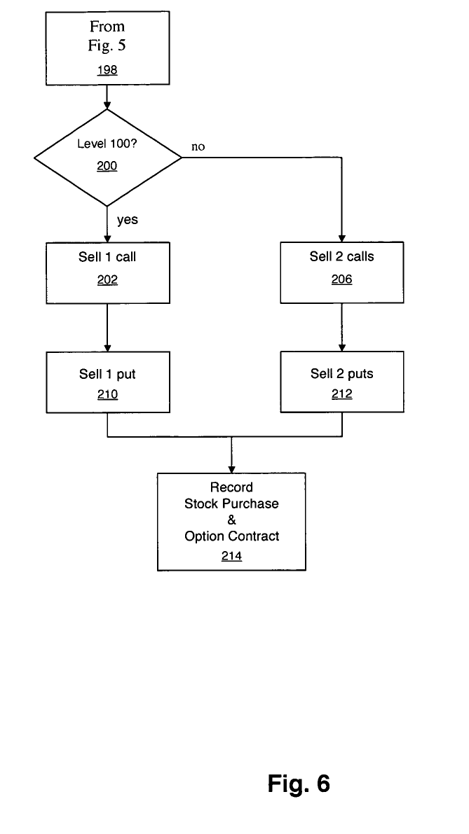

FIG. 5 illustrates an embodiment of the procedures for picking the stock to purchase. In this embodiment, a choice is made as to which stock to select and at what level: Level 100—100 shares; or Level 200—200 shares. The Levels of 100 and 200 shares are a result of the number of shares per option contract that are traded or 100 shares per option contract. In other circumstances different levels or increments may be appropriate. In this embodiment a Level 300, or higher, is not discussed because of concerns with liquidity in acquiring too many shares of stock. In other embodiments higher levels may be appropriate.

The first step is to pick the first stock on the list sorted in step 150 that is under the upper price limit (P_{UL}) 172. The reason to pick the first stock is that because of the sorting, it represents the largest option premium by selling calls on a 100 share purchase of this stock. Then consideration should be made as to whether to purchase stock at Level 200 (200 shares of one of the listed stocks instead of 100 shares of the first listed stock available under P_{UL}) 174. This determination is made by comparing the previously calculated stock price upper limit to a constraint. In this embodiment the constraint is $75.00. The parameter increases the probability of investing in high-priced stocks.

If the stock price upper limit is greater than 75 then the Level 200 purchase option should be considered 176. First divide the stock price upper limit by 2 (P_{UL}/2) 178 to get a stock Level 200 stock price upper limit (P_{UL2}) . Then scan down the list to the first stock equal to or below the Level 200 stock price upper limit 180. If the open interest value for this stock is above a Level 200 constraint/threshold 182 then proceed to step 184. If not, then keep scanning down the list for a stock at or below the Level 200 upper limit and with an open interest over the Level 200 open interest constraint (C_{L2}). In the present embodiment an appropriate level for the open interest constraint is 500. For different levels of risk different open interest constraints could be applied. In yet other embodiments liquidity parameters other than the open interest parameter could be used with different constraint values.

Although not shown in FIG. 5, if no stock is found at or below the Level 200 stock price upper limit that has an open interest above the Level 200 open interest constraint then the investor should proceed with selecting the Level 100 stock.

If a suitable Level 200 stock has been picked then the prospective results are compared to determine whether to purchase the Level 100 stock or the Level 200 stock. First determine the option bid price for the Level 200 stock 184. The Level 200 stock option bid price is multiplied by 2 in this embodiment because twice as much stock means twice as many option contracts. In step 186 and 188, the results of the option bid prices for Level 100 and Level 200 are compared. If the Level 100 result is equal or greater, than Level 100 stock is selected for purchase 190. If the Level 200 result is greater, than the Level 200 stock is selected for purchase 192. Now that either the Level 100 or Level 200 stock has been selected, proceed to FIG. 6. Now we can turn our attention back to FIG. 1.

Returning to FIG. 1 step 170 is completed—the stock and number of shares to purchase has been determined. In step 214 the stock is purchased and recorded. This can be done through many avenues. For example the purchase can be made through an online account at optionsXpress:
www.optionsxpress.com.

FIG. 6 illustrates the steps of purchasing of stock and sale of options in step 214 of FIG. 1. If the stock was picked at Level 100 200 then 100 shares of stock should be purchased 202. If the stock was picked at Level 200 204, then 200 shares should be purchased 206. In either case the number of options contracts to sell should be the number of shares purchased divided by 100 (S÷100=Op) 210.

At the end of each month the investor's income can be calculate as follows:
MI=(NP)(Op)(100)

where MI is the Monthly Income; NP is the Net Premium; Op is the Number of Contracts.

This calculation does not take into account additional profit resulting from the actual sale of the shares when/if any stocks are called away.

Returning to FIG. 1 step 214 is completed. Step 260 should only be used once a month. This step leads to the possibility of purchasing more stock. This should only be done in a position once a month. This frequency is based on the described embodiment where a front month option is sold, and which expires after one month. In step 260, an inquiry is made as to whether all of the shares of stock have been purchased by the owners of the call options. If they have, then the position is closed and the process should be begun again (step 100).

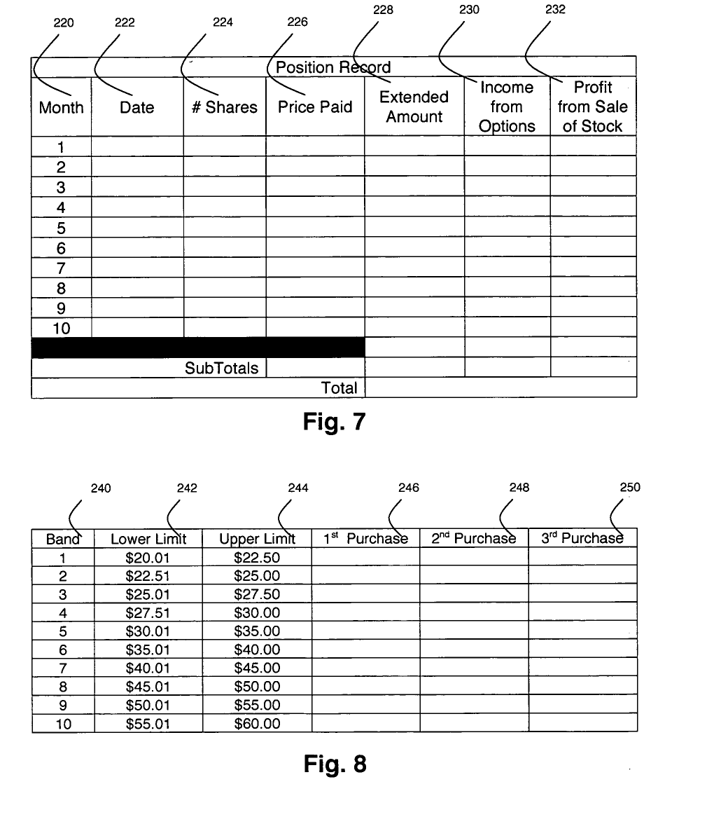

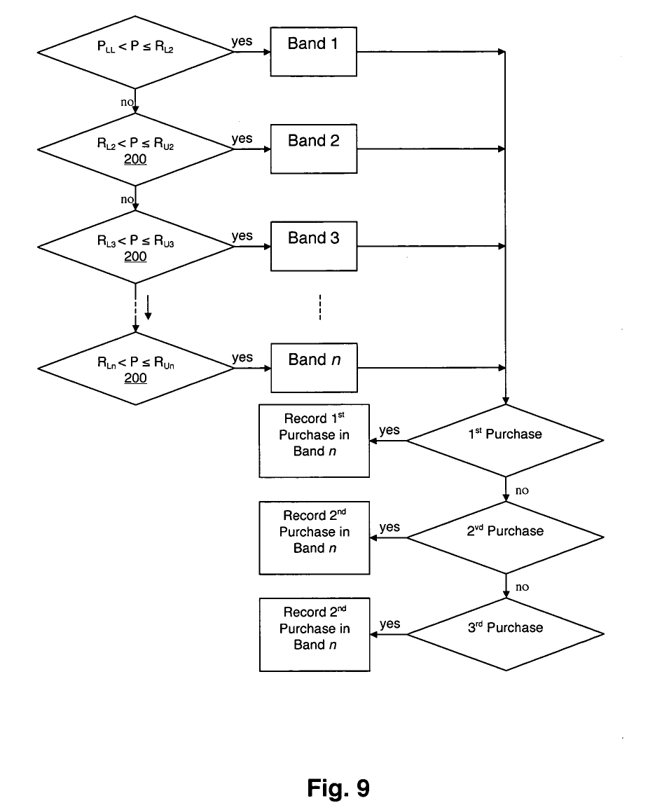

To track the performance of the position the table shown in FIG. 7 should be updated after each transaction. The first column 220 is the month of the position. In the “date” column 222 insert the date in the month that the stock was purchased. In the “# shares” column 224 insert the number of shares purchased. In the “price paid” column 226 insert the price paid per share. In the “extended amount” column 228 insert the total amount paid for the stock:
P_{E}=(P)×(S)

where P_{E} is the “extended amount”; P is the price per share and S is the number of shares.

The last two columns 230 and 232 are filled in after income is received from the options and the stock is sold.

The cost basis of the stock can be calculated/recalculated each time stock is purchased should be calculated with the following equation:

$${P}_{CB} = \frac{\sum {P}_{E}}{\sum S} \qquad [ 1 ]$$

where P_{CB} is the cost basis; ΣP_{E} is the total of the “extended amounts” for shares still owned and ΣS is the total number of shares owned.

In addition to filling in the table of FIG. 7 each month a table like the table in FIG. 8 (Band Purchase Record) can be updated. This table records the bands in which a purchase was made. The first column 240 is the band number the second and third columns 242 and 244 are the price range for the band. In this example the bands are at intervals of $2.50 for prices below $30.00 dollars and at intervals of $5.00 for prices above $30.00. If options are not available at strike prices, the limits of the bands should reflect this. For example, if there is no $27.50 option available, the Band in this region should span from $25.00 to $30.00.

When the first purchase is made in a band an X should be placed in the “First Purchase” column 246. The second time a purchase is made in the same band, an X should be placed in the “Second Purchase column 248 . . . and so on. (When stock is sold an X in the Band representing the stock sold should be erased.)

At the end of the first month one of three things will happen:
(1) If the price of the stock is higher than the strike price of the calls at the expiration (in this example, the third Friday of the month), the purchased shares will very likely be called away and the investor will be paid the strike price for each share. The profits can be calculated with the following equation:
   Y_{S}=(P₀−P_{CB})(S)−C
   where Y_{S} is the profit from the sale of stock, P₀ is the strike price in the option, P_{CB} is the cost basis of the stock, S is the number of shares sold, and C is the commission paid.

(2) If the price of the stock is lower than the strike price of the calls but above the strike price of the puts, at expiration of the options, the options will most likely expire worthless. Income for the month can be calculated with the following equation:
Y_{M}=(L)(Y_{P})−C

where Y_{M} is the monthly income; L is the level (100 for Level 100, 200 for Level 200, etc.); Y_{P} is the Net Premium sum of the call premiums and the put premiums; and C is the commission.

(3) If the price of the stock is below the price of the puts, the calls will expire and the puts will very likely be assigned. In this case the monthly profit can be calculated with the following equation:
Y_{M}=(L)(Y_{P})−C

where Y_{M} is the monthly income; L is the level (100 for Level 100, 200 for Level 200, etc.); Y_{P} is the Net Premium sum of the call premiums and the put premiums; and C is the commission.

If the puts are assigned, shares will not be purchased in the second month (next month). The investor will proceed directly to determining the calls to be sold in the second month.

Returning to FIG. 1, the Record step 214 has been completed for the first month's purchase and sales. How to proceed depends on whether all of the options have been exercised 260. In the first end of month contingency, where the stock price rose, the options were exercised and step 260 results in starting over again in step 100 to create a new position. Otherwise a decision needs to be made as to whether or not to purchase more stock. In this example, this decision should be made each Monday following the expiration of the previous options contracts. Since expiration occurs on the third Friday of the month, the decision should be made on the Monday following the third Friday of the month. The first condition of the decision is based on how many previous purchase transactions (Tₙ) have resulted in the purchase of stock 262. In this example if the number of transactions equals or exceeds a threshold of 10 purchases their calls to sell are entered 264. If not, then the next determination to make is if a put has been assigned 265. If a put has been assigned, then proceed to determining the calls to sell 264. However if the put has not been assigned, then the next determination is whether the purchase would violate a band rule. 270.

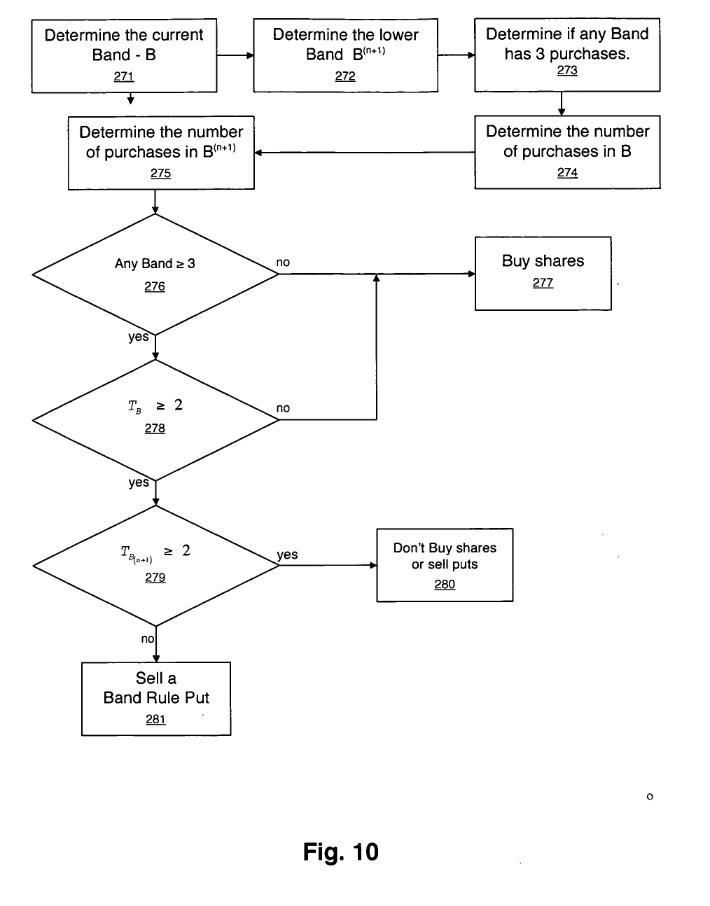

One embodiment of a band rule is illustrated in FIG. 10. First a determination must be made concerning what band the current price falls into, (B) 271. This can be determined from the current price and reference to the Band Purchase Record, like the one illustrated in FIG. 8, for the current position. From the current price band determination and reference to the Band Purchase Record, a determination can be made as to which band is the next lowest band (B₍ₙ₊₁₎) 272. The following determinations should also be made by reference to the Band Purchase Record: determine whether three (3) or more purchases have been made in any Band 273; determine the number of purchases in the current Band (B) 274; and determine the number of purchases in the next lowest band (B₍ₙ₊₁₎) 275. If three purchases have not been made in any band 276 the purchase of stock and sale of options should be made in the current band 277. Even if three (3) purchases have been made in one band, a purchase might still be made. If less than two purchases have been made in the current band (B) 278, then another purchase should be made in the current band 277 (again paired with the sale of options). This completes one embodiment of determining whether a price band rule has been violated. Other embodiments may also be suitable. The primary purpose of the band rule is to make sure that the position's price spread is appropriately dispersed. The rule is intended to avoid purchasing too many shares too close together in price.

In FIG. 10 a determination was made as to whether a position price dispersion rule was violated. If the rule was not violated and a new purchase would not bunch the holdings in a stock position too closely together, then we can return to step 300 in FIG. 1 to purchase the stock and sell the option. However, if the dispersion rule was violated than no purchases should be made until step 260 repeats the following period (in this example—the following month). In the present embodiment, if the band rule has been violated, then it may be appropriate to consider selling a put in the stock position. This determination is made in step 310. An embodiment of how to make this determination is illustrated in greater detail in FIG. 10.

Steps 271 through 278 in FIG. 10 were discussed above. The determination as to whether to sell a put proceeds at step 279. To get to step 279 it has already been determined that three purchases have been made in a single band 276 and that 2 or more purchases have been made in the current band (B) 278. If less than 2 purchases have been made in the next lowest band (B₍ₙ₊₁₎) 279, then no puts should be sold (and no stock should be purchased 280). However, if fewer than 2 purchases have been made in the next lowest band (B₍ₙ₊₁₎) 279, then a Band Rule Put should be sold 281. Now that a determination of whether to sell a put has been made, we can return to FIG. 1.

Every time a transaction is completed the tables in FIG. 7 & FIG. 8 should be updated and the cost basis calculation from equation [1] should be recalculated to calculate the new cost basis per share.

In a continuing position each month the number of calls sold is determined by the number of shares owned including the shares purchased in that month according to the following equation:
Kp=S/K_{I}

where Kp is the number of option contracts and S is the number of stocks owned and K_{I} is the number of stocks each option contract covers.

By way of example, if an investor previously held 300 shares and just purchased an additional 100 shares then 400 shares are owned. The investor will sell 4 call option contracts, assuming each contract covers 100 shares.

Each month call contracts are sold that expire the following month. The call price depends on the cost basis of the stock in the position and, the strike price higher than the cost basis. For example, if the cost basis is $40.27, then one strike above the position's cost basis would be the $45.00 strike price.

If the cost basis is just above a strike price, the investor may want to consider the call at that strike if the value of the premium is greater than the time value of the premium at the strike above the cost basis and the intrinsic value of the premium is less than a predetermined level. In the present embodiment, this predetermined level is $0.50. The time value of a premium is given by the following formula.
P=P_{T}+P_{I}

where P is the total premium; P_{T} is the time value; and P_{I} is the intrinsic value.

The intrinsic value can be calculated by the following formula (as long as P_{I} is not less than zero)
P_{I}=P_{S}−S

where P_{S} is the stock price and S is the strike price.

For example, if the cost basis is $50.15 and the premium on the $50.00 strike call is $2.35 and the premium on the $55.00 call is $0.70, then it is reasonable to sell the call with the $50.00 strike price. This may result in the loss of $0.15 a share but that is more than offset by the $2.35 made on the premiums for a net of $2.20 a share which is more than the $0.70 premium at the higher strike. However, taking the lower strike will result in losing the opportunity to make $4.85 a share on the risk of the call being exercised at the higher strike price.

If calls are not available at a strike price above the cost basis or the bid premium is so low the calls could not be sold for an amount greater than the commission, the investor should bundle the shares. The goal of bundling is to find the combination of stock purchases that can be bundled together to bring the most option premium. Bundling should only be considered if calls cannot be sold profitably against all of the shares in a position.

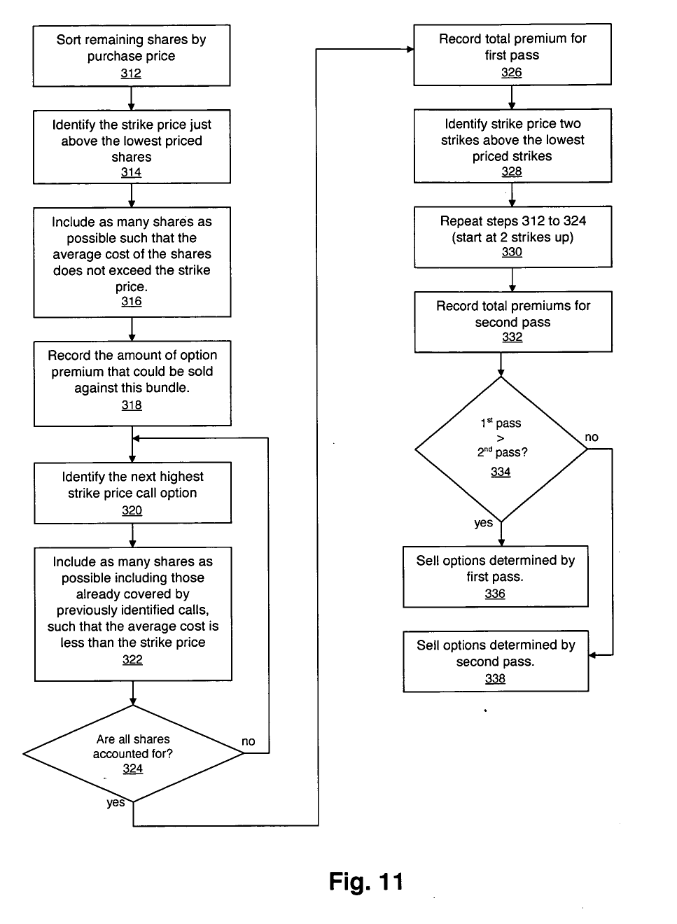

FIG. 11 illustrates one embodiment of bundling for determining what call option contracts to sell. In the first pass the shares still held in the investment are organized into discrete bundles. The first bundle includes the maximum number of shares which can be aggregated such that the average cost basis of the bundle is less than the strike price of the option just above the price of the lowest priced shares 312-316. When aggregating the shares, shares in a band can be aggregated in increments equivalent to the increments determined by the number of shares in a call contract for that stock.

Excluding the shares in the first bundle, form subsequent bundles using the same criteria for each higher strike price 320-322 until each share is included in a bundle 324. Then determine how much option premium can be sold by selling the corresponding number of contracts at the corresponding strikes, excluding bundles whose corresponding calls are not offered or whose bid price is so low that the options cannot be sold profitably. Tentatively record the total premium for this first pass for options where the options can be sold profitably. However, this might not be the most profitable set of bundles. Therefore, other bundle(s) should be considered. Repeat steps 312-324 modifying step 314 to start with the option two (2) strikes above the purchase price of the lowest shares 330. Tentatively record the total premium for the second pass for options where the options can be sold profitably. Compare the total premium for the first pass to the total premium in the second pass 334. Sell the contracts determined by the pass with the higher total premium 336 or 338.

The preceding has been a description of the process and system for a single position. The following is a description of an expanded process and system for larger accounts.

As in FIG. 1 and FIG. 2 in the single position, a Monthly Allowance must be calculated. The Monthly Allowance can be calculated as follows:
I_{MA}=I_{UC}÷C_{D}

where I_{MA} is the Monthly allowance I_{UC} is the total investment unassigned cash and C_{D} is a divisor constraint.

The divisor constraint is determined based on the size of the total stake and whether trading is done out of a margin account or a non-margin account. The stake is the total amount of investment in the account. It can be calculated with the following formula:
I_{T}=I+I_{A}+Y_{D}+Y_{S}

where I_{T} is the current stake, I is the original investment I_{A} is the sum of any additional contributions minus any withdrawals Y_{D} is all interest or dividends and Y_{S} is any profit (minus any loss) from any closed positions.

An investor's accounts can be placed into categories based on the stake and the availability of margin. One embodiment of categories and divisor constraints is illustrated in FIG. 12. Other categories and/or divisor constraints are possible and likely.

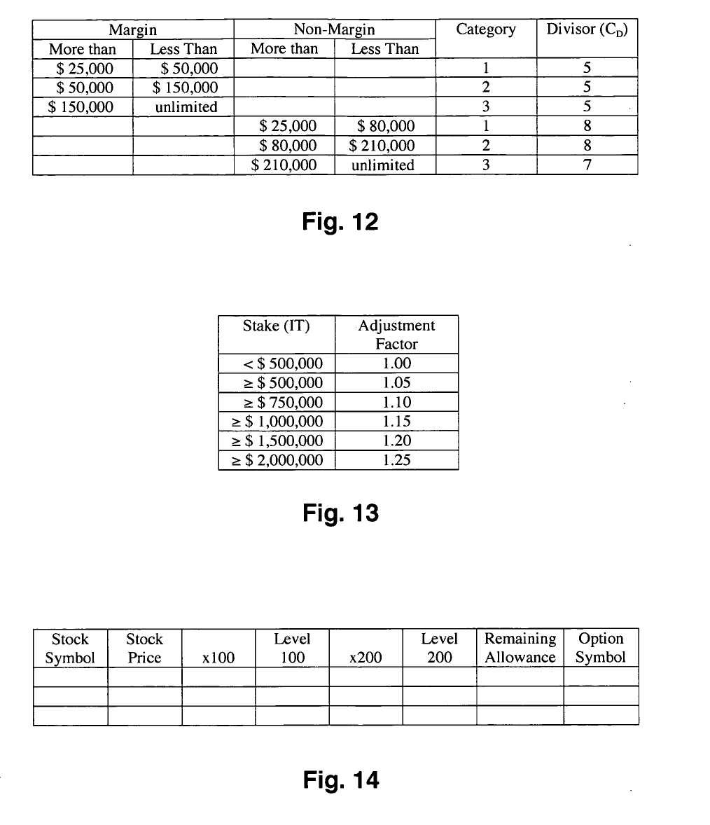

The total unassigned cash (I_{UC}) is calculated using the following formula:
I_{UC}=(I_{T})(F_{A})−I_{TA}

where I_{T} is the total investment or stake defined above; F_{A} is an adjustment factor; and I_{TA} is the investment that has been assigned.
The formula for the total investment or stake (I_{T}) was provided above. The adjustment factor is another multiplier that takes into account the fact that it is unlikely that every position will make full use of the cash reserved for that position. The larger the account, the greater the chance of unused cash, the larger the multiplier or adjustment factor. The table in FIG. 13 is one embodiment of suitable adjustment factors. The total assigned cash can be calculated with the following formula:

$${I}_{TA} = {\sum }_{n} ( {P}_{n} ) ( {C}_{{D}_{n}} ) ( {L}_{n} )$$

where I_{TA} is the total assigned cash; n is the number of open positions; Pₙ is the initial price of the stock in a position; C_{D}_{ₙ} is the divisor constraint; and Lₙ is the level of stock purchase (number of shares).

In addition to the Monthly Allowance a diversification constraint must also be calculated. It can be calculated using the following formula:
C_{DL}=0.25×I_{T}÷C_{D}

where C_{DL} is the diversification constraint; I_{T} is the Stake or total investment; and C_{D} is the divisor constraint

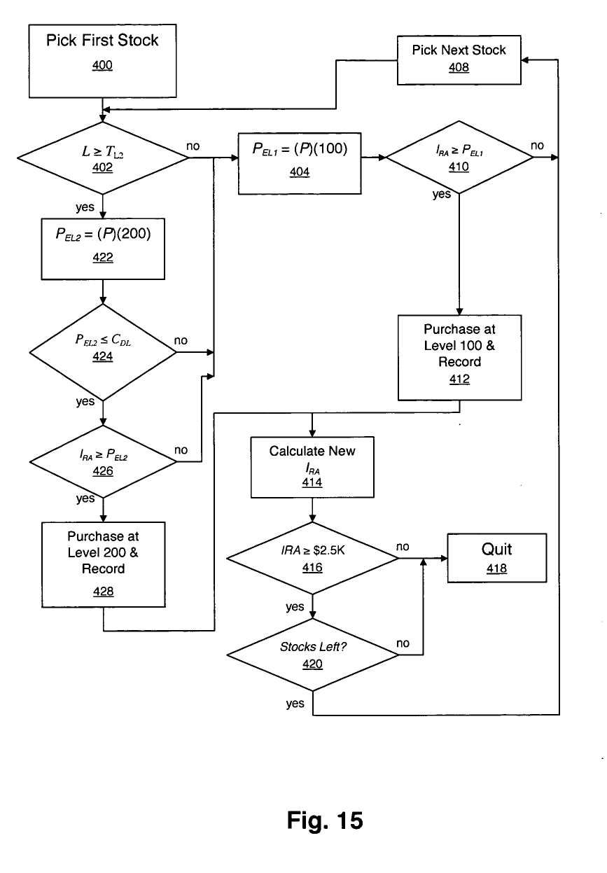

Now the input parameters for larger, multi-position accounts are known. In the preferred embodiment of multi position accounts, the screening process 130 is also modified. For category 2 accounts, the price upper limit P_{UL} is $70. In the preferred embodiment, the stock picking procedure 170 for Category 2 larger accounts is different than the procedure for single positions. When picking stocks, a table like the one illustrated in FIG. 14 and the flow chart in FIG. 15 will be helpful.

FIG. 15 is an illustration of the procedure for picking stocks in a multi-position account. From the screened and sorted list the first stock is picked 400. If the Open Interest level in that stock is NOT greater than a Level 200 threshold/constraint T_{L2} (500 in this embodiment), step 402, then a Level 100 purchase should be considered. The extended amount(P_{EL1}) of such a purchase is calculated by multiplying the stock price times 100 (the Level 100 stock increment) 404. The extended amount is then compared to the Monthly Allowance remaining (IRA) 410. If it is larger, then proceed to picking the next stock on the list 408 and begin again. If the extended amount is smaller then proceed with purchasing the stock at Level 100 and recording the purchase in the monthly purchase table (FIG. 14) 412. After the purchase the monthly allowance remaining available must be adjusted by subtracting the new purchase from the previous monthly allowance remaining 414. If the monthly allowance remaining is less than $2,500 (Minimum stock price of $25 times 100 shares) 416 then quit for the month 418. If the monthly allowance remaining is larger 416 and there are no stocks left on the list 420 then quit for the month 418. On the other hand if there are stocks left on the list 420, then proceed with picking the next stock on the list 408 and begin again.

Return to comparing the first picked stock to the Open Interest Liquidity constraint/threshold in step 402. If the threshold is equal or greater than the threshold then the extended amount for a Level 200 purchase should be calculated 422 and compared to the Diversification constraint (C_{DL}) 424 and the monthly allowance remaining (I_{RA}) 426. If it is larger than either one of these constraints 424 or 426, then a Level 100 purchase for the stock is considered (starting at step 404). However if the extended amount is below both of these constraints then a Level 200 purchase of the stock should be made and the purchase should be recorded 428. After any purchase the purchase should be subtracted from the previous monthly allowance remaining to get the new monthly allowance remaining 414. This process is repeated until the monthly allowance remaining falls below $2,500 416 or the sorted list of stocks is exhausted 420.

For each stock purchased each month the determination needs to be made as to what call options to sell. For these transactions the procedures for a single position account are followed for each position in the multi-position account(s). If someone is trading in multiple accounts, care should be taken that none of the accounts hold positions in the same stock.

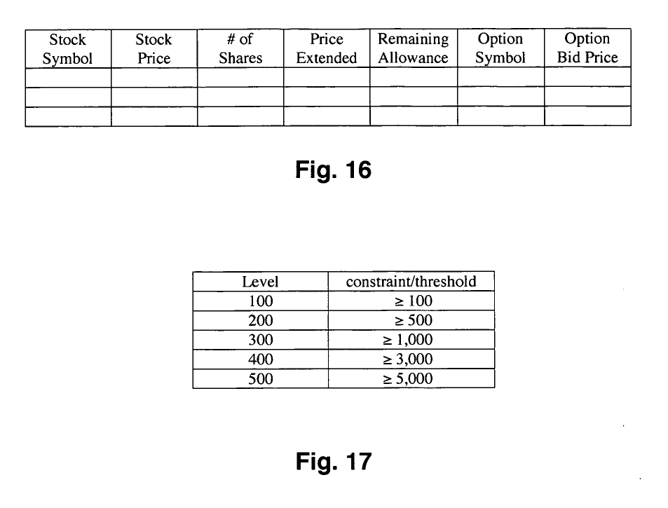

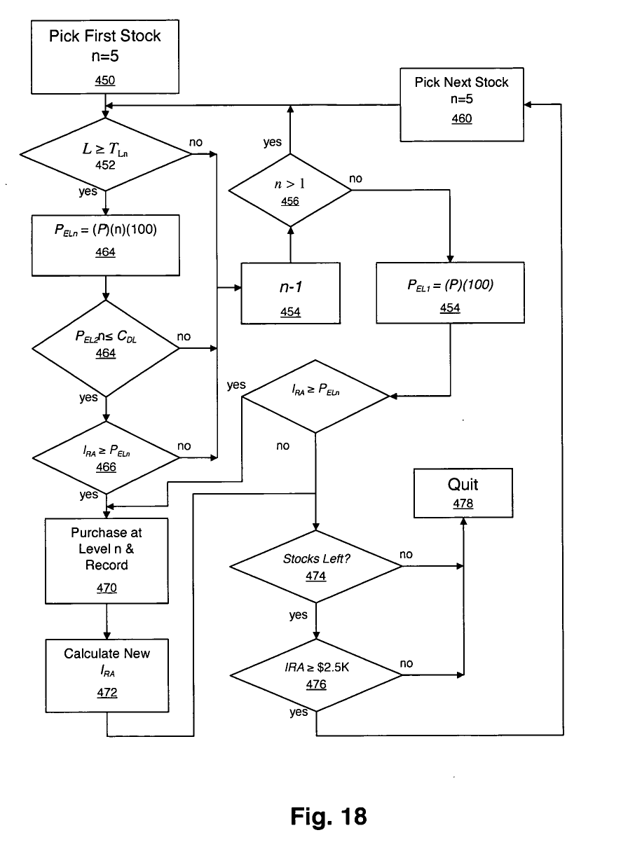

In the preferred embodiment a different stock selection procedure is used for Category 3 accounts. In single position accounts and Category 1 and Category 2 accounts only two levels of positions were considered. In Category 3 accounts more levels are considered. For example in addition to Level 100 and Level 200 positions, Level 300, 400, and 500 are considered. FIG. 16 presents an example of a reporting structure of Category 3 accounts.

Before picking the stocks the procedures for sorting the stocks for category three accounts is different in the preferred embodiment. Rather than sorting the stocks by option bid price, the stocks can be sorted by the percent downside protection. This is the option premium divided by the price of the stock.

FIG. 17 illustrates an embodiment of a procedure for picking stocks for category 3 accounts. First pick the first stock on the screened list that was sorted for a category 3 account and set “n” to 5 450. The “n” is set to 5 because the first purchase level to consider is a Level 500 purchase. The next step 452 is to compare the open interest liquidity level of the stock to the open interest liquidity threshold for the current level considered. The first time through, the relevant threshold is the Level 500 threshold. In the present embodiment the thresholds for the different levels are detailed in FIG. 17. If the threshold is not met 452, then try decreasing the level by one step (n=1) 454. If n is greater than “1” 456, then proceed trying the next level threshold 452. However if n is not greater than “1”, then calculate PEI for a level 100 purchase and compare this amount to the remaining monthly allowance. If the extended amount is less than this constraint, buy at level 100; otherwise, pick the next stock on the list (assuming there are stokes left on the list).

When the open interest level is greater than the open interest threshold for a level 452 then the extended amount for purchasing the stock at that level is calculated 462. This extended amount is then compared to both the Diversification constraint (C_{DL}) 464 and the Monthly Allowance remaining (I_{RA}) 466. If the extended amount is greater than either one of these constraints 464 466, then try the next lower purchase level by decrementing n down 1 (n−1) 454. If the extended amount is below both constraints 464 466, then stock should be purchased at the current level n 470. Once n is set equal to 1 the Diversification constraint is not checked; only the remaining Monthly Allowance constraint is tested/applied. Whenever stock is purchased the Monthly Allowance remaining (I_{RA}) should be adjusted 472 by subtracting the extended amount from the previous Monthly Allowance remaining. If the monthly allowance remaining is greater than the minimum allowable purchase; (In this embodiment $2,500 or (100)($25) where $25 is the minimum stock price) and there are stocks still on the available on the list then proceed to picking the next stock on the list and reset n to 5 460. On the other hand if either the monthly allowance remaining is below the minimum purchase or there are no stocks remaining available on the list then quit for the month 478.

For any multi-position account every month the monthly allowance should be recalculated according to the previously discussed equations before engaging in any transactions. After recalculating the Monthly Allowance, the existing positions should be maintained by following the procedures. Only after all of the existing positions have been maintained should new positions be contemplated. When contemplating new positions the procedures for screening and sorting the list of stocks should be repeated according to the category of the account.

1-11. (canceled)

12. A method of generating income from at least one stock position in an investment account, comprising:
purchasing at a market price, shares of at least one stock having high option premiums, without regard to any potential increase or decrease in the market price of the stock; and
selling covered call options for the stock to generate income.

13. The method of claim 12, wherein the step of purchasing shares of at least one stock includes:
screening a plurality of stocks for risk factors; and
of the stocks that pass the screening step, selecting the stocks with the highest call option premiums.

14. The method of claim 13, wherein the step of screening a plurality of stocks for risk factors includes eliminating stocks for companies having a risk of going bankrupt that is above a threshold bankruptcy-risk level.

15. The method of claim 13, wherein the step of selling covered call options includes selling covered call options that expire in the next calendar month, and selling the covered call options at a strike price at or just above the market price of the stock, wherein the covered call options are sold as soon as possible after current-month options expire so as to maximize a time-premium component of the option premium.

16. The method of claim 15, wherein the step of selecting the stocks positions for purchase includes selecting the stocks based on a set of criteria that depend upon the amount of capital available for investment, said criteria balancing the objectives of:
maximizing option premium income from the stock positions;
minimizing future inability to sell call options on purchased stock positions; and
maximizing diversification of the purchased stocks.

17. A method of generating income from at least one stock position in an investment account, comprising:
selecting stock positions for purchase using a set of criteria that depend upon the amount of capital available for investment, said criteria balancing the objectives of:
maximizing income from the stock positions;
minimizing the risk of any company whose stock is purchased from going bankrupt;
minimizing future inability to sell call options on purchased stock positions; and
maximizing diversification of the purchased stocks; and
selling covered call options for the stock positions to generate income.

18. The method of claim 17, wherein the step of selling covered call options for the stock positions includes selling covered call options that expire in the next calendar month, and selling the covered call options at a strike price at or just above the market price of each stock position, wherein the covered call options are sold as soon as possible after current-month options expire so as to maximize a time-premium component of the option premium.

19. The method of claim 18, further comprising, before the selecting step, the steps of:
designating a portion of the capital in the investment account as being available on a monthly basis for investment, said designated portion enabling ten equal monthly investments to be made, if the stock position is not called away at an earlier monthly expiration date; and
reserving the remaining portion of the capital for investment in future months.

20. A method of generating income from at least one stock position in an investment account having an unallocated amount of capital in cash or cash equivalents, comprising:
in a first month, utilizing a minor portion of the unallocated capital to purchase positions in stocks having high option premiums;
selling covered call options for the stocks to generate income; and
retaining the remainder of the unallocated money in cash or cash equivalents to maximize the probability of generating consistent income in subsequent months.

21. The method of claim 20, wherein the step of selling covered call options for the stocks includes selling covered call options that expire in the next calendar month, and selling the covered call options at a strike price at or just above the market price of each stock, wherein the covered call options are sold as soon as possible after current-month options expire so as to maximize a time-premium component of the option premium.

22. The method of claim 21, further comprising the steps of:
determining after a next monthly option expiration day, whether the call option on a given stock was exercised;
if the call option on the given stock was not exercised, utilizing an additional minor portion of the unallocated capital to make an additional purchase of the given stock, thereby averaging down the cost basis in the purchased stock; and
if the call option on the given stock was exercised, utilizing the minor portion of the unallocated capital to purchase a replacement stock having a high option premium.

23. The method of claim 20, further comprising, prior to utilizing a minor portion of the unallocated capital to purchase positions in stocks having high option premiums, the steps of:
screening the options for high liquidity to maximize the availability of a liquid options market in future months; and
screening the stocks for a minimum initial stock price to maximize the probability of having options available in future months with strike prices near the market price after a substantial decline in the market price.

24. The method of claim 23, wherein the step of utilizing a minor portion of the unallocated capital to purchase stocks having high option premiums includes purchasing stocks without regard to any potential increase or decrease in the market price of the stock.

25. The method of claim 20, further comprising, prior to utilizing a minor portion of the unallocated capital to purchase positions in stocks having high option premiums, the steps of:
screening a plurality of stocks for risk factors; and
eliminating stocks for companies having a risk of going bankrupt that is above a threshold bankruptcy-risk level.

26. The method of claim 20, further comprising, prior to utilizing a minor portion of the unallocated capital to purchase positions in stocks having high option premiums, the step of selecting stocks for purchase using a set of criteria that depend upon the amount of capital available for investment, said criteria balancing the objectives of:
maximizing option premium income from the stock positions:
minimizing future inability to sell call options on purchased stock positions; and
maximizing diversification of the purchased stocks.

27. The method of claim 26, wherein the criterion of minimizing future inability to sell call options on purchased stock positions is met by limiting the number of shares of a single stock that can be purchased within a predetermined range of stock prices.

28. The method of claim 27, wherein, after monthly purchases of a given stock have been made for a number of months, the criterion of maximizing option premium income from the stock positions is met by performing the steps of:
calculating an overall average cost basis in the given stock;
determining that the market price of the given stock has fallen to a level at which a covered call option cannot be profitably sold at or above the overall average cost basis in the given stock;
determining whether one or more covered call options can be profitably sold on a subset of the monthly purchases of the given stock, said subset having a lower average cost basis than the overall cost basis in the given stock;
if one or more covered call options can be profitably sold on a subset of the monthly purchases of the given stock, selling the one or more covered call options on the subset of the monthly purchases of the given stock; and
if one or more covered call options cannot be profitably sold on a subset of the monthly purchases of the given stock, foregoing the selling of covered call options on the given stock in the current month, and making an additional monthly purchase of the given stock to average down the cost basis of the given stock.

29. The method of claim 28, further comprising determining whether one or more covered calls can be profitably sold at a strike price just below the average cost in the given stock, wherein profit is determined solely on the basis of the time-premium component of the option premium.

30. The method of claim 20, further comprising the steps of:
selling, only in a first month in which a given stock is purchased, a one-month put option for the given stock at a strike price below the current market price of the given stock;
determining in a second month, whether the put option was exercised, thereby causing the automatic purchase of additional shares of the given stock;
if the put option was not exercised, purchasing additional shares of the given stock in a scheduled monthly purchase;
if the put option was exercised, foregoing the scheduled monthly purchase in the second month; and
in a third and subsequent months, selling covered call options for the accumulated shares of the given stock to generate income.

31. The method of claim 20, wherein the step of utilizing a minor portion of the unallocated capital to purchase stocks having high option premiums includes purchasing stocks without regard to any potential increase or decrease in the market price of the stock, and wherein the step of selling covered call options for the stocks includes selling covered call options that expire in the next calendar month, and selling the covered call options at a strike price at or just above the market price of each stock, wherein the covered call options are sold as soon as possible after current-month options expire so as to maximize a time-premium component of the option premium, wherein the method further comprises:
selling, only in a first month in which a given stock is purchased, a one-month put option for the given stock at a strike price below the current market price of the given stock;
selecting stocks for purchase using a set of criteria that depend upon the amount of capital available for investment, said criteria balancing the objectives of:
maximizing option premium income from the stock positions;
minimizing future inability to sell call options on purchased stock positions; and
maximizing diversification of the purchased stocks;
making additional monthly purchases of the selected stocks utilizing additional minor portions of the unallocated capital; and
after each monthly purchase of a given stock:
calculating an overall average cost basis in the given stock;
determining whether the market price of the given stock has remained at a level at which a covered call option can be profitably sold at or above the overall average cost basis in the given stock;
if the market price of the given stock has remained at a level at which a covered call option can be profitably sold at or above the overall average cost basis in the given stock, selling covered call options in proportion to the total shares owned of the given stock;
if the market price of the given stock has fallen, and is no longer at a level at which a covered call option can be profitably sold at or above the overall average cost basis in the given stock, determining whether one or more covered call options can be profitably sold on a subset of the monthly purchases of the given stock, said subset having a lower average cost basis than the overall cost basis in the given stock;
if one or more covered call options can be profitably sold on a subset of the monthly purchases of the given stock, selling the one or more covered call options on the subset of the monthly purchases of the given stock; and
if one or more covered call options cannot be profitably sold on a subset of the monthly purchases of the given stock, foregoing the selling of covered call options on the given stock in the current month, and making an additional monthly purchase of the given stock to average down the cost basis of the given stock.
